(19) United States
(12) Patent Application Publication
(10) Pub. No.: US 2009/0041006 A1
(43) Pub. Date: Feb. 12, 2009

(54) METHOD AND SYSTEM FOR PROVIDING INTERNET KEY EXCHANGE

(75) Inventor: Chuan-Feng Chiu, Taiwan (TW)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/908,822

(22) PCT Filed: Mar. 8, 2006
(86) PCT No.: PCT/JP2006/305063

§ 371 Date: Sep. 17, 2007

(30) Foreign Application Priority Data
Mar. 21, 2005 (CN) 200510055950.5

(51) Int. Cl. H04L 12/66

(52) U.S. Cl. 370/352

(57) ABSTRACT

In a method and system for providing Internet Key Exchange (IKE) during a Session Initiation Protocol (SIP) signaling session, the method includes: enabling a caller end node device to send a first SIP request message to a callee end node device, wherein the first SIP request message includes a payload unit of a first IKE quick mode initial message; enabling the callee end node device to respond to the first SIP request message with an SIP response message, wherein the SIP response message including includes a payload unit of an IKE quick mode response message; and enabling the caller end node device to send a second SIP request message to the callee end node device, wherein the second SIP request message includes a payload of a second IKE quick mode initial message.

### TECHNICAL FIELD

The invention relates to a method and system for conducting a Session Initiation Protocol (SIP) signaling session, more particularly to a method and system for providing Internet Key Exchange (IKE) during an SIP signaling session.

### BACKGROUND ART

With the continuous development of packet networks, such as the Internet, traditional Circuit Network-based voice telecommunications is gradually changing. Among many feasible solutions, the Internet Protocol (IP) is a major communications protocol that can be used for voice transmission, i.e., Voice over Internet Protocol (VoIP). The Session Initiation Protocol (SIP) is a standard set by the Internet Engineering Task Force (IETF) for realizing VoIP applications.

In considering security concerns with respect to these applications, the IP Security (IPSec) protocol which is widely used in IP version 4 (IPv4), and which is a key element in IP version 6 (IPv6), naturally becomes a candidate for security solution.

Referring to FIG. 1, generally speaking, to protect a VoIP application, a caller end 91 and a callee end 92 must conduct a two-stage process 93 for establishing a secure tunnel (e.g., by using IPSec/Internet Key Exchange (IKE)), and another process 94 for completing communications settings so as to conduct the required medium (voice) communication (using SIP) that is protected by the secure tunnel. However, the aforesaid scheme has a problem, i.e., two independent processes have to be performed: the process 93 of establishing the secure tunnel, and the signaling session 94. This will increase the amount of transmission or the waiting time when establishing a secure voice communications tunnel, and will increase the complexity for the user in use.

In addition, U.S. Patent Publication No. US20030217165, entitled “END-TO-END AUTHENTICATION OF SESSION INITIATION PROTOCOL MESSAGES USING CERTIFICATES” discloses a method that supports end-to-end authentication capability. In the method, the authentication parameters are combined with SIP so as to enable an SIP node receiving an SIP request message to authenticate the sender of the authentication request. However, even if the sender of the SIP request message can be authenticated using certificates, the aforesaid U.S. patent publication fails to disclose that a secure tunnel is provided once communications are initiated. Therefore, the voice communications information may be stolen by theft or by deceit.

### DISCLOSURE OF INVENTION

Therefore, an object of the present invention is to provide a method for providing Internet Key Exchange during a Session Initiation Protocol signaling session so as to protect VoIP applications in an IPSec/IKE environment to thereby simplify the process of establishing a secure tunnel during secure communications, reduce the complexity of setting up the secure tunnel and the signaling session, and achieve seamless integration of the IPSec/IKE and SIP.

Accordingly, the method for providing Internet Key Exchange during a Session Initiation Protocol signaling session of the present invention includes the following steps. First, a caller end node device sends a first SIP request message to a callee end node device, wherein the first SIP request message includes a payload unit of a first IKE quick mode initial message. Then, the callee end node device responds to the first SIP request message with an SIP response message, wherein the SIP response message includes a payload unit of an IKE quick mode response message. Next, the caller end node device sends a second SIP request message to the callee end node device, wherein the second SIP request message includes a payload of a second IKE quick mode initial message.

In addition, another object of the present invention is to provide a system for providing Internet Key Exchange during a Session Initiation Protocol signaling session so as to protect VoIP applications in an IPSec/IKE environment to thereby simplify the process of establishing a secure tunnel during secure communications, reduce the complexity of setting the secure tunnel and the signaling session, and achieve seamless integration of the IPSec/IKE and SIP.

Accordingly, the system for providing Internet Key Exchange during a Session Initiation Protocol signaling session of the present invention includes a caller end node device 11 and a callee end node device 12. The caller end node device 11 is used to send a first SIP request message and a second SIP request message, wherein the first SIP request message includes a payload unit of a first IKE quick mode initial message, and the second SIP request message includes a payload of a second IKE quick mode initial message. The callee end node device 12 is used to receive the first SIP request message and the second SIP request message, and to respond to the first SIP request message with an SIP response message, wherein the SIP response message includes a payload unit of an IKE quick mode response message.

### BRIEF DESCRIPTION OF DRAWINGS

Other features and advantages of the present invention will become apparent in the following detailed description of the preferred embodiments with reference to the accompanying drawings, of which:

FIG. 1 is a diagram depicting a conventional art communication session, in which an IPSec tunnel is first established using the IKE protocol, and a VoIP communication process is subsequently performed under the protection of the IPSec tunnel;

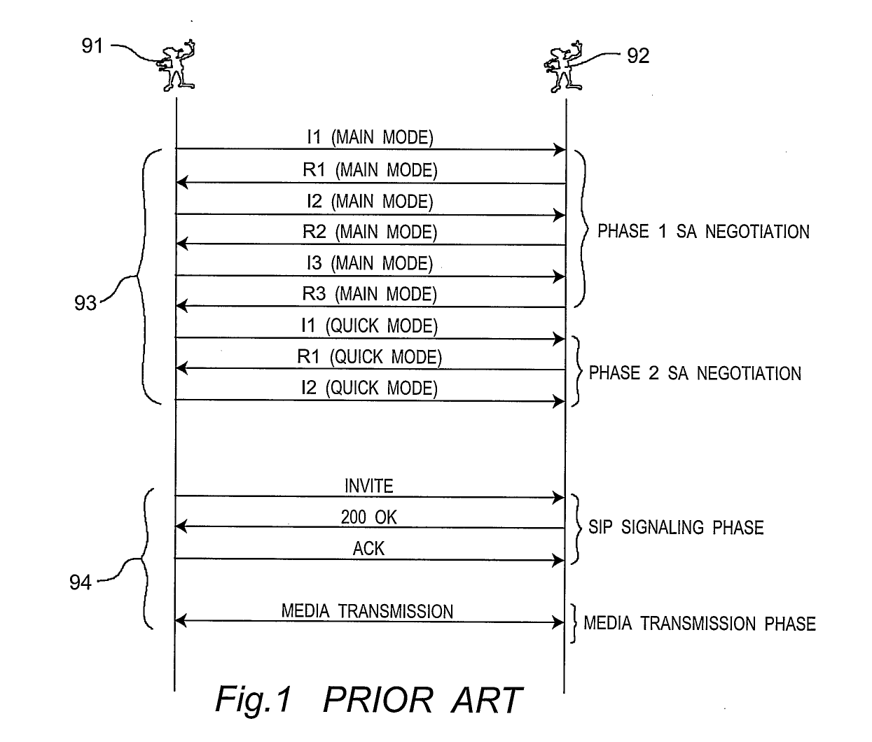

FIG. 2 is a system architecture diagram, illustrating a preferred embodiment of a system for providing IKE during an SIP signaling session according to the present invention;

FIG. 3 is a block diagram illustrating a caller end node device and a callee end node device in the preferred embodiment of the system according to the present invention;

FIG. 4 is a communication session diagram, illustrating a preferred embodiment of a method for providing IKE during the SIP signaling session according to the present invention;

FIG. 5 is a communication session diagram, illustrating another preferred embodiment of a method for providing IKE during the SIP signaling session according to the present invention;

FIG. 6 is a schematic view illustrating SIP messages having IKE payloads in the present invention;

FIG. 7 is a flowchart illustrating a preferred embodiment of a message receiving process of the caller end node device in the present invention; and

FIG. 8 is a flowchart illustrating a preferred embodiment of a message receiving process of the callee end node device in the present invention.

### BEST MODE FOR CARRYING OUT THE INVENTION

Before the present invention is described in greater detail, it should be noted that like elements are denoted by the same reference numerals throughout the disclosure.

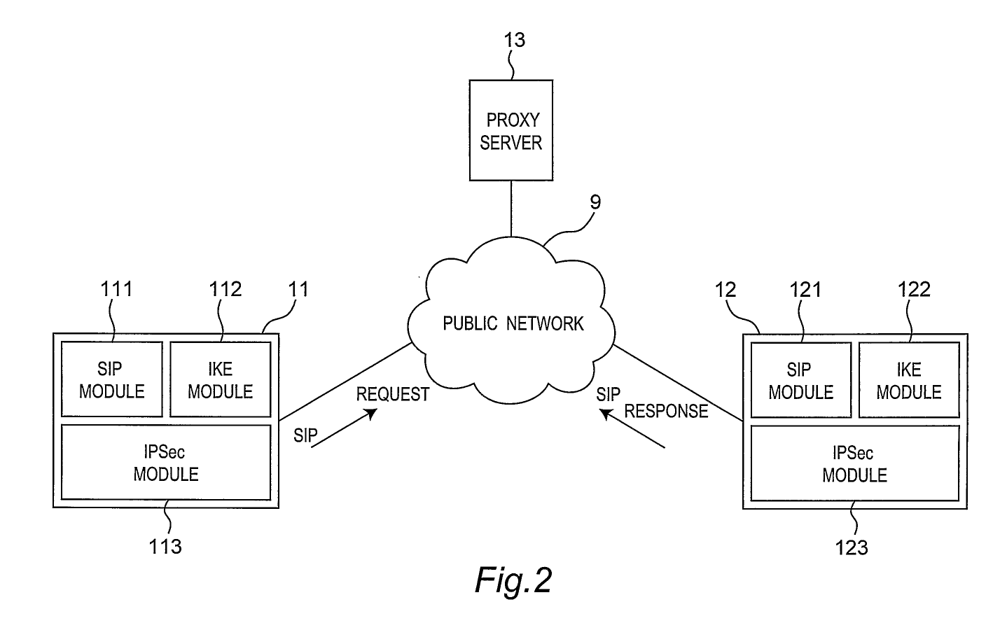

Referring to FIG. 2, the preferred embodiment of a system for providing IKE during an SIP signaling session according to the present invention is shown to include a caller end node device 11, a callee end node device 12, and a proxy server 13. The caller end node device 11 is used to send an SIP request to the callee end node device 12, and includes an SIP module 111, an IKE module 112, and an IPSec module 113. The callee end node device 12 is used to send an SIP response to the caller end node device 11, and includes an SIP module 121, an IKE module 122, and an IPSec module 123. The proxy server 13 is interposed between the caller end node device 11 and the callee end node device 12, and is used to receive the SIP request sent from the caller end node device 11 for transmission to the callee end node device 12, and for receiving the SIP response sent from the callee end node device 12 for transmission to the caller end node device 11.

When the caller end node device 11 intends to establish a secure communications tunnel with the callee end node device 12, the caller end node device 11 will send an SIP request to a public network 9. Then, the SIP request will be sent to the callee end node device 12 through the proxy server 13 or directly. The caller end node device 11 will use the SIP module 111 to establish an SIP request message/parse an SIP response message/process an SIP message, and uses the IKE module 112 to establish an IKE payload/parse the IKE payload/process the IKE payload so as to send the request to the callee end node device 12. The callee end node device 12 will receive the request message from the public network 9, and uses the SIP module 121 to establish an SIP request message/parse an SIP response message/process an SIP message, and uses the IKE module 122 to establish an IKE payload/parse the IKE payload/process the IKE payload so as to respond to the request of the caller end node device 11. After completing the setup of the secure voice tunnel and the media communication attributes, the session medium communication will be protected by the IPSec module 113 of the caller end node device 11 and the IPSec module 123 of the callee end node device 12, thereby achieving the objective of secure voice communications.

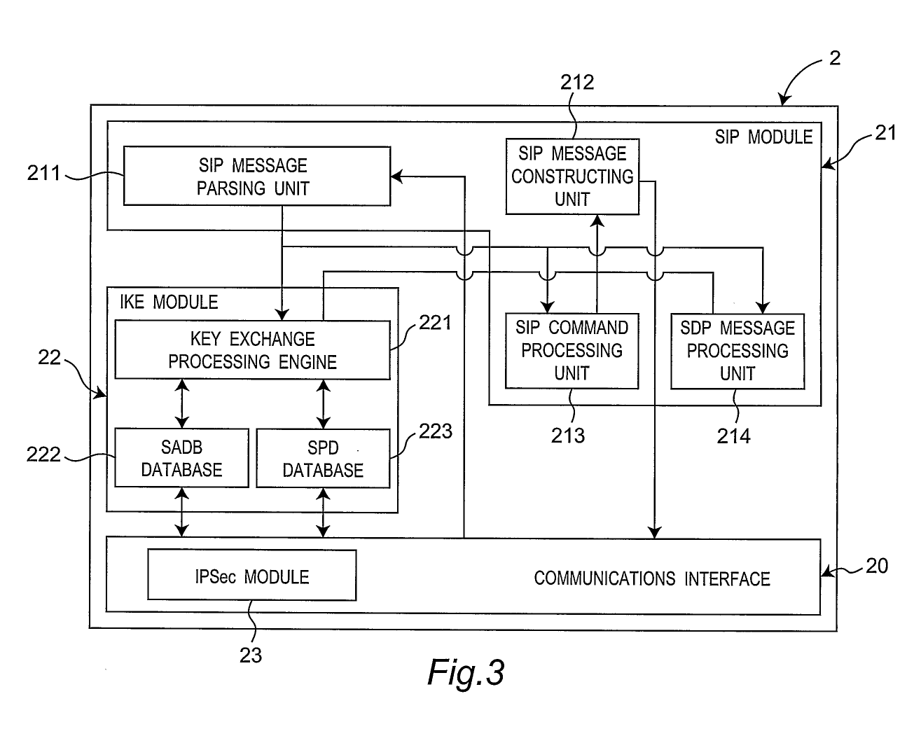

The caller end node device 11 and the callee end node device 12 in FIG. 2 can be implemented using a terminal device 2 shown in FIG. 3. The terminal device 2 includes an SIP module 21, an IKE module 22, and a communications interface 20. The SIP module 21 includes an SIP message parsing unit 211, an SIP message constructing unit 212, an SIP command processing unit 213, and a Session Description Protocol (SDP) message processing unit 214. The IKE module 22 includes a key exchange processing engine 221, a security association database (SADB) database 222, and a security policy database (SPD) database 223. The communications interface 20 includes an IPSec module 23. That is, the SIP module 111 and the SIP module 121 in FIG. 2 are equivalent to the SIP module 21 in FIG. 3; the IKE module 112 and the IKE module 122 in FIG. 2 are equivalent to the IKE module 22 in FIG. 3; and the IPSec module 113 and the IPSec module 123 in FIG. 2 are equivalent to the IPSec module 23 in FIG. 3.

The SIP message parsing unit 211 is used to receive the SIP response message from a destination terminal device or from a source terminal device, and analyzes the message to identify portions such as an SIP message header and a SIP message payload. The SIP message constructing unit 212 is responsible for establishing the SIP request or response message sent to the destination terminal device or source terminal device. The SIP command processing unit 213 is an executing unit for the received SIP message. The SDP message processing unit 214 is responsible for operations related to the media transmission attributes. The key exchange processing engine 221 is responsible for processing the key exchange payload, including establishment of the key exchange payload, parsing of the key exchange payload, execution of key exchange, and setting of security associations of the SADB database 222 and the SPD database 223. The SADB database 222 is used to store Security Association (SA). The SPD database 223 stores security policies defining security parameters used in specific communication tunnels. The IPSec module 23 is responsible for processing secure voice communications. The communications interface 20 is responsible for receiving packets from the public network 9, and the sending of packets to the public network 9.

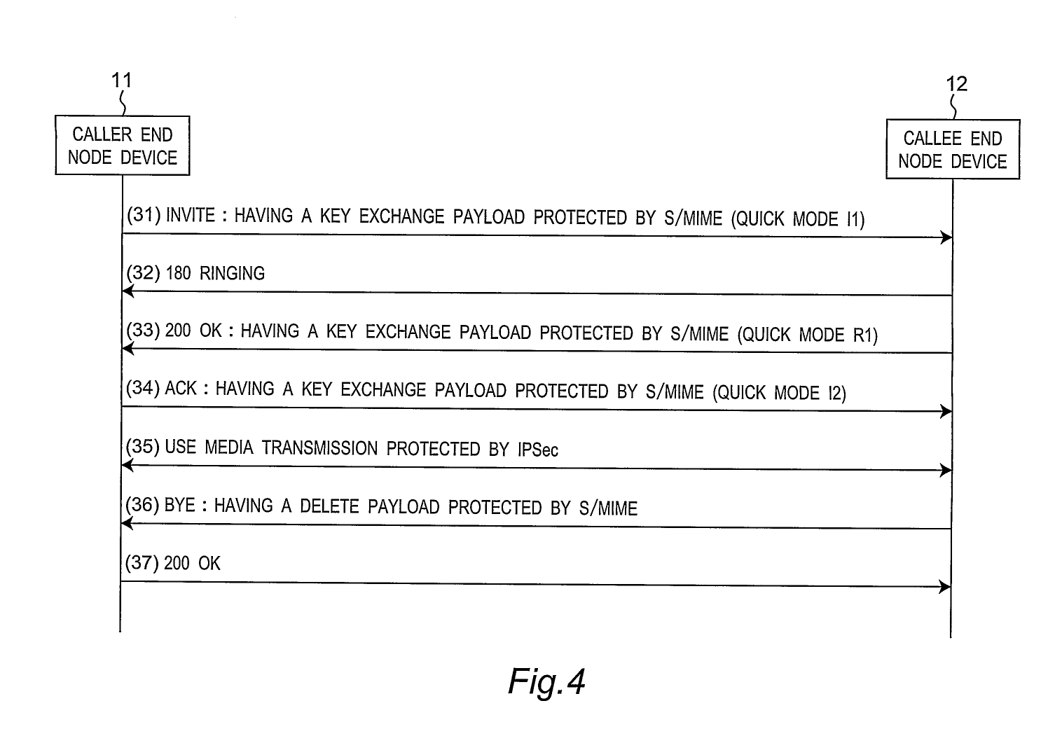

FIG. 4 shows a preferred embodiment of a communication session according to the method of the present invention. The communication session in FIG. 4 is based on an SIP operation carrying key exchange information for establishing the secure voice communications tunnel, in which the caller end node device 11 and the callee end node device 12 are directly involved in a negotiation of the SIP operation without using any proxy server 13 therebetween (see FIG. 2).

First, as shown in procedure (31), the caller end node device 11 sends a first SIP request message to the callee end node device 12, wherein the first SIP request message includes a payload unit of a first IKE quick mode initial message. That is, the caller end node device 11 prepares an SIP Invite message having the first IKE quick mode initial message as protected by a Secure Multipurpose Internet Mail Extension (S/MIME), and sends the same to the callee end node device 12 so as to negotiate the media communication attributes and SA that will serve as parameters of IPSec kernel. In the SIP Invite message, the key exchange payload will be protected by S/MIME so as to ensure confidentiality of sensitive security information.

Next, as shown in procedure (32), the callee end node device 12, after receiving the SIP Invite message sent from the caller end node device 11, will send a 180 Ringing message to the caller end node device 11 so as to notify the caller end node device 11 that the call is waiting to be answered by the user of the callee end node device 12.

Then, as shown in procedure (33), the callee end node device 12 uses an SIP response message to respond to the first SIP request message, wherein the SIP response message includes a payload unit of an IKE quick mode response message. That is, after processing the SIP Invite request, the callee end node device 12 responds with a 200 OK response message having the IKE quick mode response message protected by S/MIME.

Subsequently, as shown in procedure (34), after the caller end node device 11 has received and processed the aforesaid response message, the caller end node device 11 sends a second SIP request message to the callee end node device 12, wherein the second SIP request message includes a payload of a second IKE quick mode initial message. That is, the caller end node device 11 sends an SIP ACK message having the second IKE quick mode initial message protected by S/MIME to the callee end node device 12.

After completing the aforesaid procedures, setting of the media transmission attributes including encoding information, etc., is completed. Besides, SA will also be set in the aforesaid SIP messages. Thus, establishment of the secure voice communications is completed. Accordingly, session voice transmission protected by IPSec can be performed as shown in procedure (35).

When the session is ended, the user of one of the caller end node device 11 and the callee end node device 12 will hang up first. For example, as shown in FIG. 4, if the callee end node device 12 hangs up first, the callee end node device 12 will send a third SIP request message protected by S/MIME to the caller end node device 11 as shown in procedure (36) s as to delete SA to ensure consistent security between the caller end node device 11 and the callee end node device 12, wherein the third SIP request message is SIP Bye, and includes an IKE Delete payload. Accordingly, as shown in procedure (37), after the SA with respect to the secure voice communications tunnel is deleted, the caller end node device 11 will send a 200 OK message to notify the callee end node device 12.

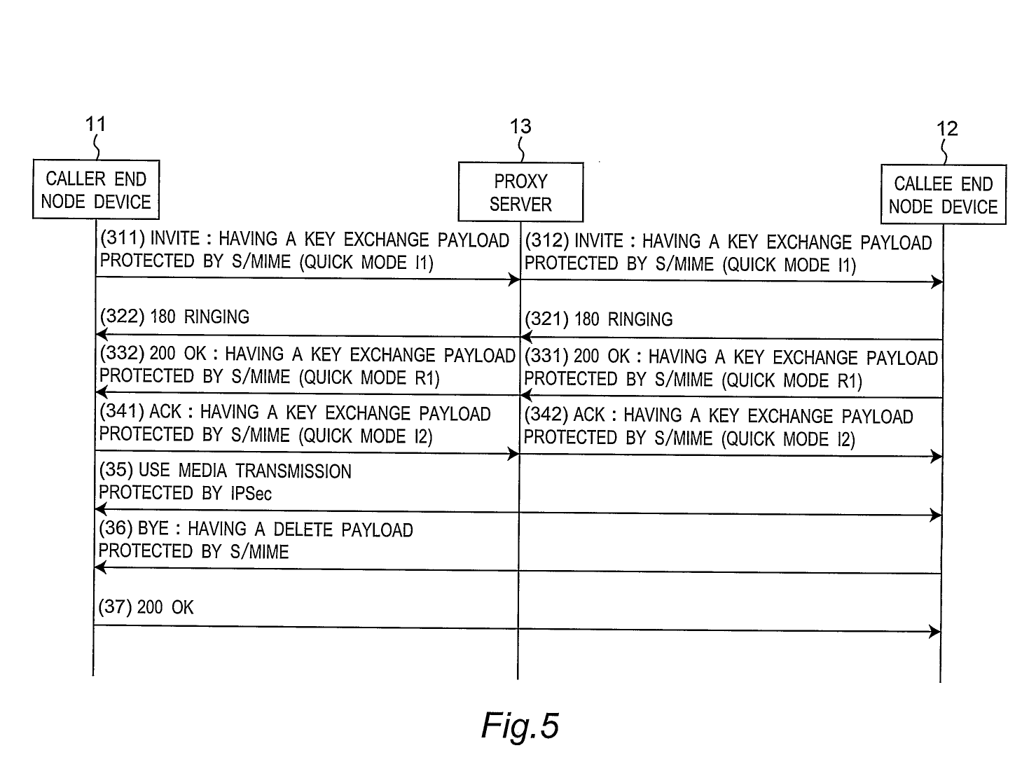

FIG. 5 shows another preferred embodiment of the communication session according to the method of the present invention. The communication session in FIG. 5 is based on an SIP operation carrying key exchange information for establishing a secure voice communications tunnel, wherein the caller end node device 11 and the callee end node device 12 employ the proxy server 13 so that the three of them are jointly involved in a negotiation of the SIP operation.

First, as shown in procedure (311), the caller end node device 11 prepares an SIP Invite message having a first IKE quick mode initial message protected by S/MIME, and sends the same to the relay proxy server 13. The proxy server 13 is a relay, and is used to forward the SIP Invite message having the first IKE quick mode initial message protected by S/MIME to the callee end node device 12 as shown in procedure (312).

The callee end node device 12 receives the SIP Invite message after the SIP Invite message has been transmitted through two procedures. Then, as shown in procedure (321), the callee end node device 12 sends a 180 Ringing message to the proxy server 13. Next, as shown in procedure (322), the proxy server 13 forwards the 180 Ringing message to the caller end node device 11 to notify the caller end node device 11 that the call is waiting to be answered by the user of the callee end node device 12.

Subsequently, as shown in procedure (331), the callee end node device 12 sends a 200 OK response message having an IKE quick mode response message protected by S/MIME to the proxy server 13 after processing the SIP Invite message. Then, as shown in procedure (332), the proxy server 13 forwards the 200 OK response message having the IKE quick mode response message protected by S/MIME to the caller end node device 11.

Thereafter, as shown in procedure (341), after the caller end node device 11 has received and processed the response message, the caller end node device 11 sends an SIP ACK message having a second IKE quick mode initial message protected by S/MIME to the proxy server 13. Then, as shown in procedure (342), the proxy server 13 forwards the SIP ACK message having the second IKE quick mode initial message protected by S/MIME to the callee end node device 12.

After completing the aforesaid procedures, setting of media transmission attributes including encoding information, etc., are completed, and SA will also be set in the aforesaid SIP messages. Thus, establishment of the secure voice communications is completed. Accordingly, session voice transmission protected by IPSec can be performed as shown in procedure (35).

When the session is ended, the user of one of the caller end node device 11 and the callee end node device 12 will hang up first. For example, as shown in FIG. 5, if the callee end node device 12 hangs up first, the callee end node device 12 sends an SIP Bye message protected by S/MIME and having an IKE Delete payload to the caller end node device 11 as shown in procedure (36) so as to delete SA to thereby ensure consistent security between the caller end node device 11 and the callee end node device 12. Thus, as shown in procedure (37), after the SA with respect to the secure voice communications tunnel is deleted, the caller end node device 11 will send a 200 OK message to notify the callee end node device 12.

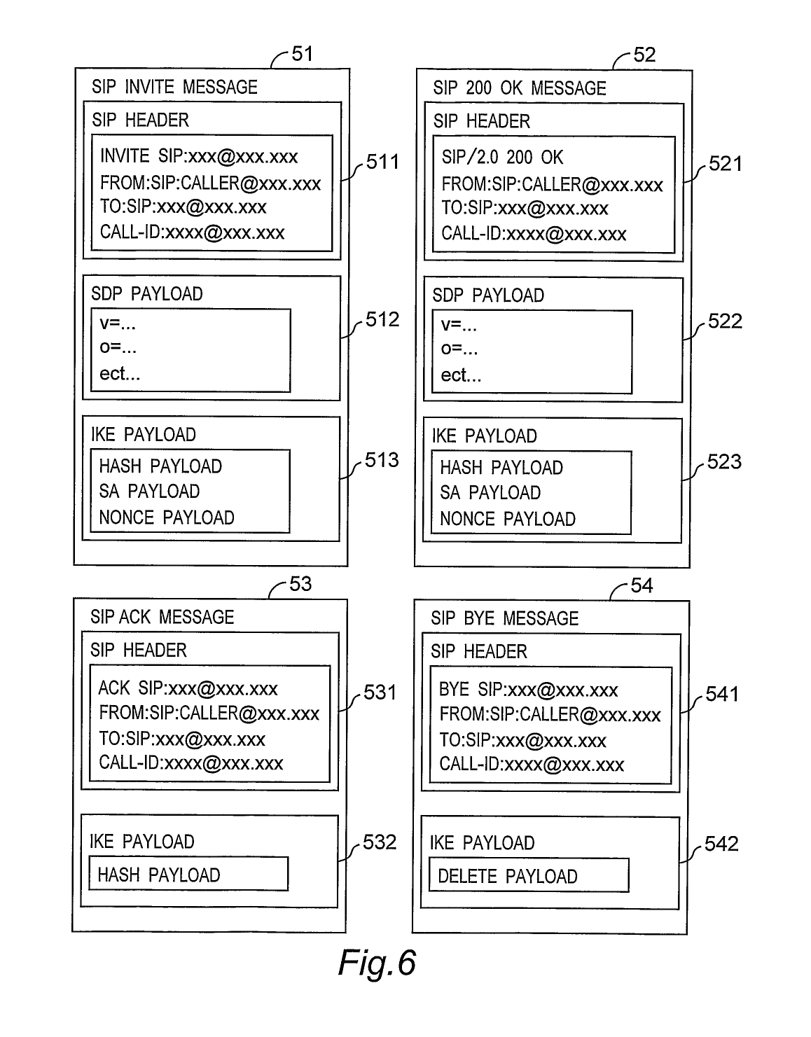

Referring to FIGS. 4 and 6, the SIP messages in the present invention include an SIP Invite message 51, an SIP 200 OK message 52, an SIP ACK message 53, and an SIP Bye message 54. The SIP Invite message 51 includes an SIP header 511, an SDP payload 512, and an IKE payload 513. The SIP header 511 discloses messages related to SIP operations, and includes communication information, such as the caller's identification code, etc. The SDP payload 512 discloses media communication attributes required for confirmation or for negotiation with other SIP nodes. The IKE payload 513 includes a HASH payload, an SA payload, and a Nonce payload for negotiating SA with other SIP nodes, so as to initiate the communication setup process.

The SIP 200 OK message 52 includes an SIP header 521, an SDP payload 522, and an IKE payload 523. The SIP header 521 discloses messages related to SIP operations, and includes communication information, such as the caller's identification code, etc. The SDP payload 522 discloses the media communication attributes confirmed or negotiated by the callee end node device 12. The IKE payload 523 includes a HASH payload, an SA payload, and a Nonce payload for negotiating SA and responding to security parameters and media attributes, wherein the callee end node device 12 agrees to the SA so as to notify the caller end node device 11 that the callee end node device 12 has answered the call.

The SIP ACK message 53 includes an SIP header 531 and an IKE payload 532. The SIP header 531 discloses messages related to SIP operations, and includes communication information, such as the caller's identification code, etc. The IKE payload 532 includes a HASH payload for confirming SA settings so as to respond to the callee end node device 12 that communication has been established.

The SIP Bye message 54 includes an SIP header 541 and an IKE payload 542. The SIP header 541 discloses messages related to SIP operations, and includes communication information, such as the caller's identification code, etc. The IKE payload 542 includes a Delete payload for deleting SA related to the secure voice communications tunnel after hanging up. To ensure the confidentiality of the IKE payload, the IKE payloads 513, 523, 532, and 542 in all the SIP messages are protected by S/MIME.

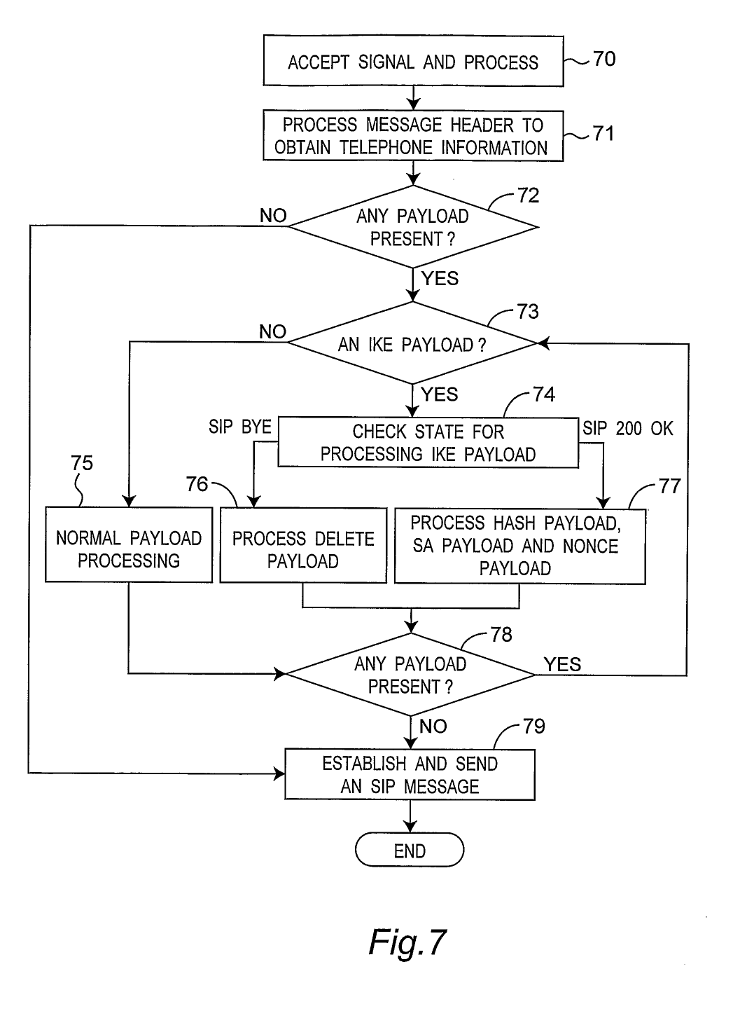

Reference is made to FIGS. 3, 4, 6, and 7, wherein FIG. 7 illustrates a preferred embodiment of a message receiving process of the caller end node device 11 in the present invention. During the signaling session, the caller end node device 11 sends an SIP Invite message 51 to the callee end node device 12 to request a voice communication, and the callee end node device 12 will respond to the caller end node device 11 with an SIP 200 OK message 52. For the caller end node device 11, it will receive the signal message sent from the callee end node device 12 in response as shown in step 70. Then, as shown in step 71, the caller end node device 11 will process the message and parse the header of the message so as to obtain communication-related information. Next, as shown in step 72, the caller end node device 11 will inspect the message to determine the presence of any payload therein. If a payload is present, the caller end node device 11 will inspect whether the payload is an IKE payload, as shown in step 73. If the payload is not an IKE payload, as shown in step 75, a conventional module is used to process the payload, wherein the payload includes an SDP payload 522 containing media transmission attributes related to voice communication or a common text payload, etc. If the payload is an IKE payload, the caller end node device 11 will use S/MIME to decrypt the IKE payload. Then, as shown in step 74, the caller end node device 11 will inspect the processing state of the device to determine the type of action to be taken in accordance with the contents of the IKE payload.

If the caller end node device 11 is in an “SIP 200 OK” state, the caller end node device 11 will use the key exchange processing engine 221 to process the IKE payload 523 which includes the HASH payload, the SA payload, and the Nonce payload, as shown in step 77. If the caller end node device 11 is in an “SIP Bye” state, the caller end node device 11 will use the key exchange processing engine 221 to process the IKE payload 542 which includes the Delete payload, as shown in step 76, so as to delete the SA in the SADB database 222, and the security policies in the SPD database 223.

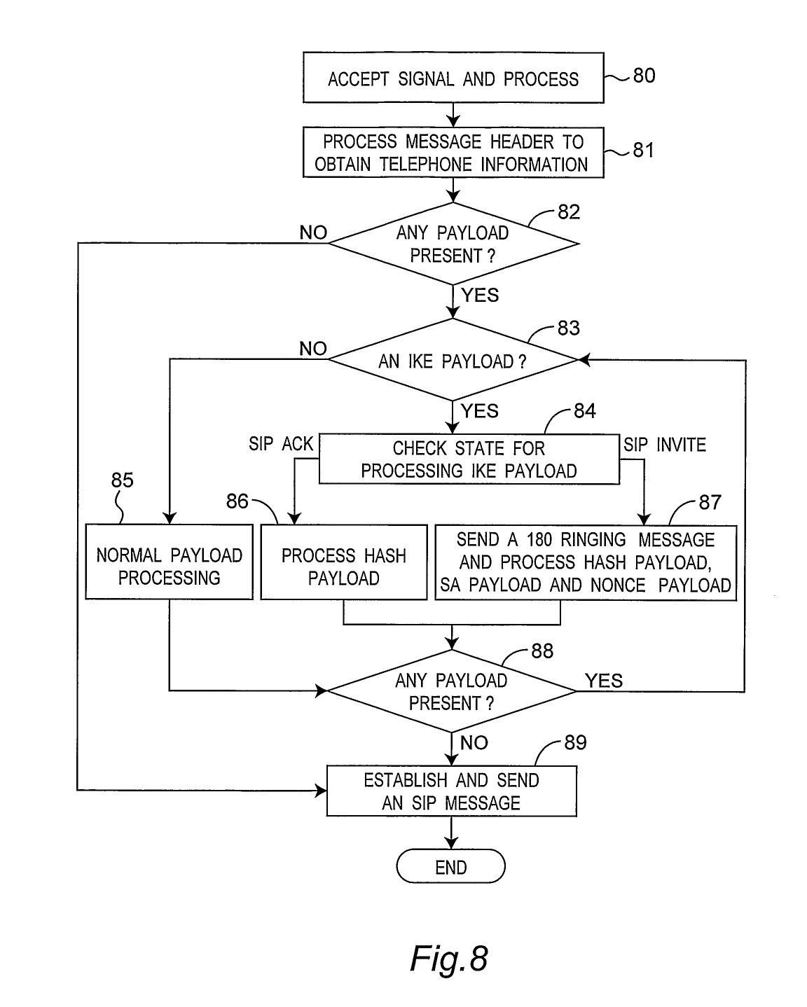

It is noted that the caller end node device 11 will be in the “SIP Bye” state of FIG. 7 and step 76 will be performed only when it is the callee end node device 12 which hangs up. If it is the caller end node device 11 which hangs up, the “SIP Bye” state and the corresponding Delete payload processing step will not appear in the flowchart of FIG. 7, and will appear in the flowchart of FIG. 8 instead.

After the IKE payload is processed, the information required for SA and the security policies will be stored or updated in the SADB database 222 and the SPD database 223. Then, as shown in step 78, the caller end node device 11 will inspect once again the presence of any payload. If no payload is present, as shown in step 79, the caller end node device 11 will establish and send a corresponding SIP message in accordance with the response message from the callee end node device 12. On the contrary, if a payload is present, the flow returns to step 73 to inspect the type of the payload and to process the payload.

Reference is made to FIGS. 3, 4, 6, and 8, wherein FIG. 8 illustrates a preferred embodiment of a message receiving process of the callee end node device 12 in the present invention. During the signaling session, the caller end node device 11 will send an SIP Invite message 51 to the callee end node device 12 to request a voice communication, and the callee end node device 12 will respond to the caller end node device 11 with an SIP 200 OK message 52. For the callee end node device 12, it will first receive the signal message sent from the caller end node device 11. Then, as shown in step 81, the callee end node device 12 will process the message and parse the header of the message so as to obtain communicated-related information. Next, as shown in step 82, the callee end node device 12 will inspect the message to determine the presence of any payload therein. If a payload is present, the callee end node device 12 will inspect if the payload is an IKE payload, as shown in step 83. If the payload is not an IKE payload, as shown in step 85, a conventional module is used to process the payload, wherein the payload includes an SDP payload 512 containing media transmission attributes related to voice communication or a common text payload, etc. If the payload is an IKE payload, the callee end node device 12 will use S/MIME techniques to decrypt the IKE payload. Then, as shown in step 84, the callee end node device 12 will inspect the processing state of the device to determine the type of action to be taken in accordance with the contents of the IKE payload.

If the callee end node device 12 is in an “SIP Invite” state, as shown in step 87, the callee end node device 12 will use the key exchange processing engine 221 to process the IKE payload 513 which includes the HASH payload, the SA payload, and the Nonce payload. If the callee end node device 12 is in an “SIP ACK” state, as shown in step 86, the callee end node device 12 will use the key exchange processing engine 221 to process the IKE payload 532 which includes the HASH payload, and confirms the key exchange information.

After the IKE payload is processed, the information required for the SA and the security policies will be stored or updated in the SADB database 222 and the SPD database 223. Then, as shown in step 88, the callee end node device 12 will inspect once again the presence of any payload. If no payload is present, the callee end node device 12 will establish and transmit a corresponding SIP message according to the response message from the caller end node device 11, as shown in step 89.

In sum, the method and system for providing IKE during the SIP signaling session of this invention is through carrying an IKE payload in an SIP message to protect VoIP applications in an IPSec/IKE environment, thereby simplifying the process of establishing a secure tunnel during secure communications, reducing the complexity of setting up the secure tunnel and the signaling session, and achieving seamless integration of the IPSec/IKE and SIP.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

### INDUSTRIAL APPLICABILITY

The present invention can be applied to the method and system for providing internet key exchange during signaling session of a Session Initiation Protocol.

1. A method for providing Internet Key Exchange (IKE) during a Session Initiation Protocol (SIP) signaling session, said method comprising:
(a) enabling a caller end node device to send a first SIP request message to a callee end node device, wherein the first SIP request message includes a payload unit of a first IKE quick mode initial signal;
(b) enabling the callee end node device to respond to the first SIP request message with an SIP response message, wherein the first SIP response message includes a payload unit of an IKE quick mode response message; and
(c) enabling the caller end node device to send a second SIP request message to the callee end node device, wherein the second SIP request message includes a payload of a second IKE quick mode initial message.

2. The method for providing Internet Key Exchange during a Session Initiation Protocol signaling session as claimed in claim 1, wherein the first SIP request message is an SIP Invite.

3. The method for providing Internet Key Exchange during a Session Initiation Protocol signaling session as claimed in claim 1, wherein the payload unit of the first IKE quick mode initial message includes a HASH payload, an SA payload, and a Nonce payload.

4. The method for providing Internet Key Exchange during a Session Initiation Protocol signaling session as claimed in claim 1, wherein the SIP response message is an SIP 200 OK.

5. The method for providing Internet Key Exchange during a Session Initiation Protocol signaling session as claimed in claim 1, wherein the payload unit of the IKE quick mode response message includes a HASH payload, an SA payload, and a Nonce payload.

6. The method for providing Internet Key Exchange during a Session Initiation Protocol signaling session as claimed in claim 1, wherein the second SIP request message is an SIP ACK.

7. The method for providing Internet Key Exchange during a Session Initiation Protocol signaling session as claimed in claim 1, wherein the payload of the second IKE quick mode initial message is a HASH payload.

8. The method for providing Internet Key Exchange during a Session Initiation Protocol signaling session as claimed in claim 1, wherein the first SIP request message, the SIP response message, and the second SIP request message are protected by S/MIME.

9. The method for providing Internet Key Exchange during a Session Initiation Protocol signaling session as claimed in claim 1, further comprising a step of enabling the caller end node device to send a third SIP request message to the callee end node device after step (c), wherein the third SIP request message is SIP Bye, and includes an IKE Delete payload.

10. The method for providing Internet Key Exchange during a Session Initiation Protocol signaling session as claimed in claim 9, wherein the third SIP request message is protected by S/MIME.

11. The method for providing Internet Key Exchange during a Session Initiation Protocol signaling session as claimed in claim 1, further comprising a step of enabling the callee end node device to send a third SIP request message to the caller end node device after step (c), wherein the third SIP request message is SIP Bye, and includes an IKE Delete payload.

12. The method for providing Internet Key Exchange during a Session Initiation Protocol signaling session as claimed in claim 11, wherein the third SIP request message is protected by S/MIME.

13. A system for providing Internet Key Exchange during a Session Initiation Protocol signaling session, comprising:
a caller end node device for sending a first SIP request message and a second SIP request message, wherein the first SIP request message includes a payload unit of a first IKE quick mode initial message, and the second SIP request message includes a payload of a second IKE quick mode initial message; and
a callee end node device for receiving the first SIP request message and the second SIP request message, and for responding to the first SIP request message with an SIP response message, wherein the SIP response message includes a payload unit of an IKE quick mode response message.

14. The system for providing Internet Key Exchange during a Session Initiation Protocol signaling session as claimed in claim 13, wherein the first SIP request message is an SIP Invite.

15. The system for providing Internet Key Exchange during a Session Initiation Protocol signaling session as claimed in claim 13, wherein the payload unit of the first IKE quick mode initial message includes a HASH payload, an SA payload, and a Nonce payload.

16. The system for providing Internet Key Exchange during a Session Initiation Protocol signaling session as claimed in claim 13, wherein the SIP response message is an SIP 200 OK.

17. The system for providing Internet Key Exchange during a Session Initiation Protocol signaling session as claimed in claim 13, wherein the payload unit of the IKE quick mode response message includes a HASH payload, an SA payload, and a Nonce payload.

18. The system for providing Internet Key Exchange during a Session Initiation Protocol signaling session as claimed in claim 13, wherein the second SIP request message is an SIP ACK.

19. The system for providing Internet Key Exchange during a Session Initiation Protocol signaling session as claimed in claim 13, wherein the payload of the second IKE quick mode initial message is a HASH payload.

20. The system for providing Internet Key Exchange during a Session Initiation Protocol signaling session as claimed in claim 13, wherein the first SIP request message, the SIP response message, and the second SIP request message are protected by S/MIME.

21. The system for providing Internet Key Exchange during a Session Initiation Protocol signaling session as claimed in claim 13, wherein the caller end node device is further used to send a third SIP request message to the callee end node device, the third SIP request message being SIP Bye and including an IKE Delete payload.

22. The system for providing Internet Key Exchange during a Session Initiation Protocol signaling session as claimed in claim 21, wherein the third SIP request message is protected by S/MIME.

23. The system for providing Internet Key Exchange during a Session Initiation Protocol signaling session as claimed in claim 13, wherein the callee end node device is further used to send a third SIP request message to the caller end node device, the third SIP request message being SIP Bye and including an IKE Delete payload.

24. The system for providing Internet Key Exchange during a Session Initiation Protocol signaling session as claimed in claim 23, wherein the third SIP request message is protected by S/MIME.

25. The system for providing Internet Key Exchange during a Session Initiation Protocol signaling session as claimed in claim 13, further comprising a proxy server interposed between the caller end node device and the callee end node device for receiving the first SIP request message and the second SIP request message sent from the caller end node device for subsequent transmission to the callee end node device, and for receiving the SIP response message sent from the callee end node device for subsequent transmission to the caller end node device.
